(19) United States
(12) Patent Application Publication
(10) Pub. No.: US 2008/0072636 A1
(43) Pub. Date: Mar. 27, 2008

(54) KNOB OPERATED ELECTROMECHANICAL LOCK CYLINDER

(75) Inventors: Toby Padilla, Denver, CO (US); Bertrand Roland, Hamburg (DE)

Correspondence Address: SHERIDAN ROSS PC, 1560 BROADWAY, SUITE 1200, DENVER, CO, 80202, US

(73) Assignee: Assa Abloy Identification Technology Group AB, Stockholm (SE)

(21) Appl. No.: 11/534,509

(22) Filed: Sep. 22, 2006

(51) Int. Cl. E05B 49/00

(52) U.S. Cl. 70/278.7

(57) ABSTRACT

The invention concerns an electromechanical lock cylinder comprising a housing in which a rotatable shaft is mounted which is connected to a lock tappet to operate a locking mechanism, and at least one knob for turning said shaft. According to the invention, in a rest position, the knob is freely turnably arranged on said shaft and that electromechanically driven locking means are provided in said shaft or in said knob for, in an operating position, coupling the shaft with the knob.

### FIELD OF THE INVENTION

The invention concerns an electromechanical lock cylinder comprising a housing in which a rotatable shaft is mounted which is connected to a lock tappet to operate a locking mechanism, and at least one knob for turning said shaft.

### BACKGROUND OF THE INVENTION

Such electromechanical lock cylinders are well known in the prior art. Document EP 1 065 335 A1 discloses a lock cylinder which is operated by a knob on the one side and by a key on the other side. The knob is firmly connected to a shaft. On the opposite side of the cylinder housing there is provided a slot for inserting the key. The lock cylinder is further provided with electric coupling means which couple the lock core with the lock tappet upon receiving an authorization signal from an access control unit which reads an access signal from the key. After authorization has been detected and the coupling means has coupled the lock core with the lock tappet, the lock can be opened by the key. The knob is firmly connected to the lock tappet and the lock mechanism can be opened or closed.

Document WO 2005/001224 A1 discloses a knob operated lock cylinder where the lock tappet of which is freely rotatably mounted on the knob shaft. A locking pin is forced into a hole of a ring by an electric motor drive in which the ring carries the lock tappet. The access control unit is located in the knob which is firmly connected to the shaft.

### SUMMARY OF THE INVENTION

In some situations it is not possible to arrange the coupling means between the locking tappet and the shaft or the lock core. It is an object of the invention to provide an electromechanical lock cylinder which can be used in many different kinds of doors or lock casings.

The object is solved by the invention in that, in a rest position, the knob is freely turnably arranged on said shaft and that electromechanically driven locking means are provided in said shaft or in said knob for, in an operating position, coupling the shaft with the knob. With that, the rotating parts can be easily adapted to the locking mechanism.

According to a preferred embodiment of the invention the locking means comprise at least one locking pin which is movable between a rest position in which it is not engaged with said knob or shaft and an operating position in which it is engaged with said knob or shaft. The locking pin may be moved by an eccentric which is driven by an electric motor drive. Such an eccentric with an electric motor drive can be placed in the shaft without any problems.

In an alternative embodiment of the invention the locking pin is moved by an electromechanical drive. Such an electromechanical device requires only little built-in space and is controllable in an easy manner.

Preferably, the locking pin is engageable with said shaft or knob in more than one position of the knob relative to the shaft. Then, the knob must only be turned until the next engaging position is reached for allowing the locking pin to become engaged.

Further, it can be provided that the locking pin is moved and held in the operating position under tension. Then, an engagement of the knob and the shaft is possible even if the locking pin is not in the position to engage the corresponding recess or hole within the shaft or knob. The knob must only be turned until the next engaging position is reached. Then, the locking pin is moved into the recess or hole due to the tension. With such an arrangement it is only required to generate one single authorization signal upon which the locking pin is moved into a position in which it is able to connect the shaft to the knob. If the knob is turned accordingly, the locking pin will engage the corresponding locking hole. Upon a release signal, the locking pin will be moved in a position in which no engagement is possible.

It is preferable that, in the axial direction of the shaft, the knob is fixed on said shaft. This has the advantage that the knob cannot be pulled off the shaft. The lock can only be operated by said knob and any misuse is prevented.

The lock cylinder can be a half-cylinder comprising one knob on the one end and the locking tappet on the opposite end of the housing. It is also possible that the lock cylinder is a double-sided cylinder comprising on its both sides a knob.

Within the lock cylinder, the arrangement of the driving means and the access control unit means is arbitrary. However, it is preferred that the driving means are arranged in said shaft and an access control unit for generating an access signal upon which the driving means will couple the knob with the shaft is arranged in said knob. With that, the mechanical locking parts may be located on or in the shaft only and the access control unit means may be arranged in the knob. Then, it is only required to change the knob in order to install other access control techniques. It is also possible that the driving means and locking means are arranged in the knob and an access control unit for generating an access signal upon which the driving means will couple the knob with the shaft is arranged in said shaft.

### BRIEF DESCRIPTION OF THE DRAWINGS

The invention is described below in detail with the help of the attached schematic drawings wherein

FIG. 1 is a longitudinal sectional view of the lock cylinder of the invention, and

FIG. 2 is a cross-sectional view along line A-A in FIG. 1.

### DETAILED DESCRIPTION OF THE INVENTION

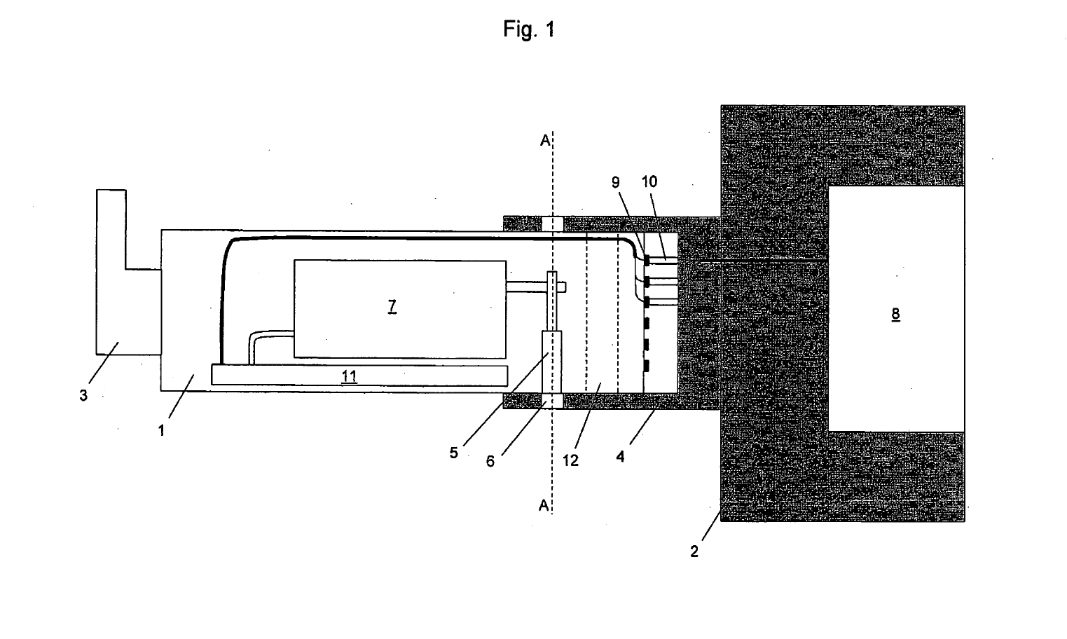

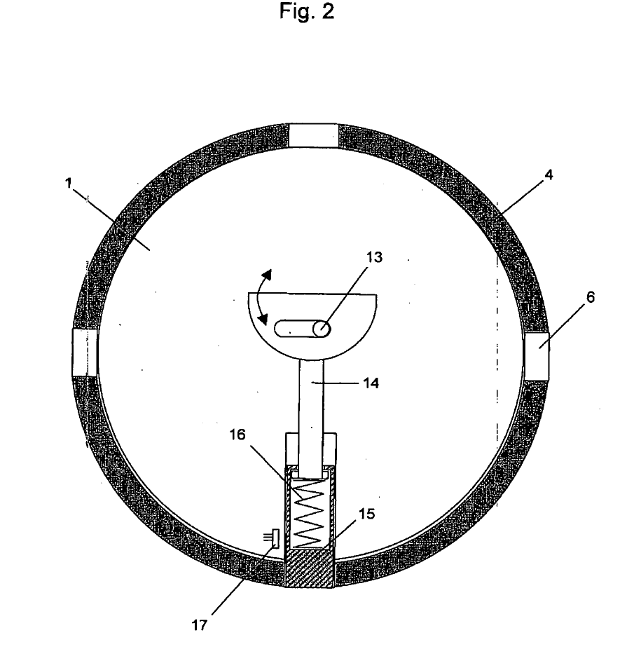

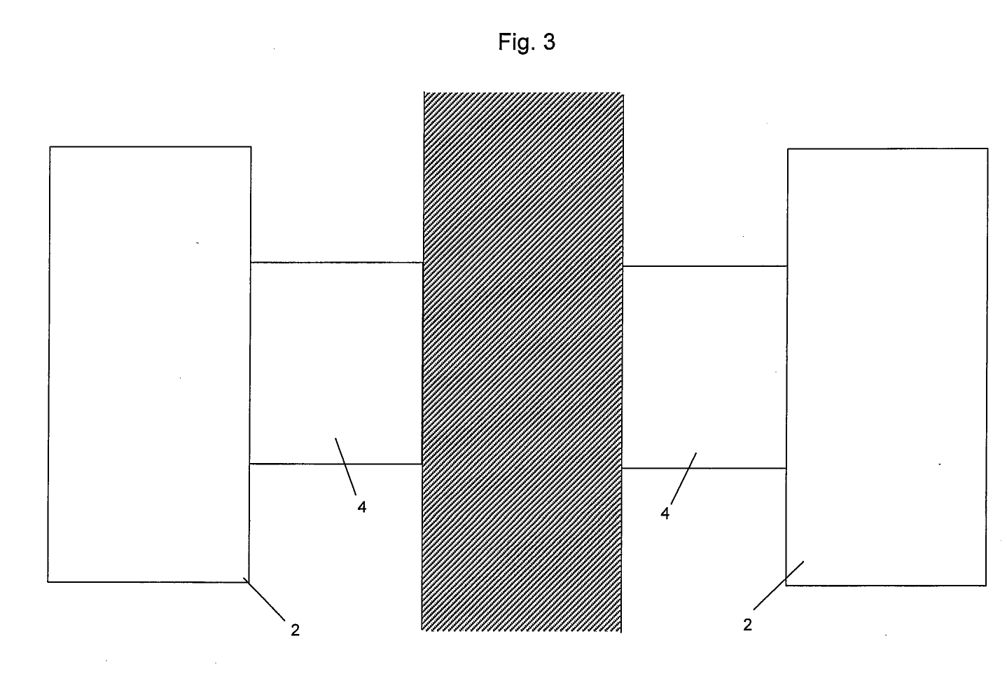

In FIGS. 1 and 2, the shaft 1 of a lock cylinder is shown. The shaft is provided with a lock tappet 3 on the one end and a knob 2 on the opposite end. The lock tappet 3 is firmly connected to the shaft 1 so that rotation of the lock tappet 3 is realized. The knob 2 serves for turning the shaft 1 in the housing (not shown) of the lock cylinder. The knob 2 can freely rotate on the shaft 1 or it may engage and rotate the shaft 1. There are fixing means provided which hold the knob 2 on the shaft 1 in the axial direction.

The lock cylinder is further provided with an access control unit 8 which generates an authorization signal after receiving an access signal from a key or key-card. The access signal may be transmitted via wireless communication. Upon generation of the authorization signal an electric motor drive 7 arranged in a recess of the shaft 1 drives a locking pin 5 into a recess or hole 6 in the socket 4 of the knob 2. The electric motor drive 7 turns an eccentric 13 which moves a rod 14 connected to the locking pin 5. With this arrangement a connection between the knob 2 and shaft 1 is provided. The lock tappet 3 can then be turned by the knob 2.

The locking pin 5 is movable in the shaft 1 in the radial direction between a recessed position and an extended position. The rod 14 is movable against the force of a spring 16 within a sleeve 15 of the locking pin 5. With this arrangement it is possible to move the rod 14 into its extended position, the operating or engaging position, even if the locking pin 5 is not in an aligned position or in an engaged position with the recess or hole 6 of the socket 4 of the knob 2. If the knob 2 is turned until the recess or hole 6 is opposite to or aligned with the locking pin 5, as it is shown in FIG. 2, the locking pin 5 is forced into the recess or hole 6 by the expansion of the spring 16. As shown in FIG. 3, there may be provided a plurality of receses or holes 6 in the socket 4 of the knob 2. In the example of FIG. 2, an engaging position is provided each 90° along the periphery of the socket 4. A sensor 17 may be provided to detect the position of the locking pin 5. The sensor 17 may be a hall sensor or any other suitable type of sensor capable of detecting the presence or lack thereof of the sleeve 15 in one of the holes 6. The sensor 17 then relays the presence information to a control unit 11 and access control unit 8.

The authorization signal for operating the electric motor drive 7 is transmitted to the control unit 11 and access control unit 8 by a slip ring arrangement. In the embodiment of FIG. 2, three contact rings 9 of increasing diameter are placed on the front face of the shaft 1. There are corresponding contact pins 10 provided on the inner side of the knob 5 facing the front face of the shaft 1. The pins 10 are in electric contact with the contact rings 9. Wireless transmission of the authorization signal between the control unit 11 and the access control unit 8 may also be possible.

The knob 2 with the access control unit 8 can be easily changed. It is only required to provide a knob with the desired access control technique which can be mounted on the free end of the shaft 1. For further security a drill plate 12 may be provided in front of the locking pin 5 within the shaft 1 in order to prevent drilling and tampering of the locking means. The housing of the lock cylinder preferably has a size such that the recesses or holes 6 are covered. A protection shield (not shown) may be provided which extends to the knob 5 such that the socket 4 cannot be reached.

For operating the lock a key or key-card is held in front of the knob 2. The access control unit 8 receives the access signal. After detecting the authorized access signal an authorization signal is generated by the access control unit 8 and is transmitted to the control unit 11. The control unit 11 generates an electric signal upon which the electric motor drive 7 turns the eccentric 13. The eccentric 13 extends the rod 14 radially outwards. If the sleeve 15 of the locking pin 5 is aligned with a locking hole 6 of the socket 4 of the knob, the locking pin 5 engages the hole 6. The shaft can be turned by the knob.

If the sleeve 15 is not in an engaging position aligned with a recess or hole 6, the rod 14 is moved into the sleeve 15 and compresses the spring 16. The sleeve is now under compression with the effect that, upon turning the knob 5 until a locking hole 6 of the socket 4 of the knob 5 is opposite to the sleeve 15, the sleeve will be forced into the recess or hole 6. Then, the shaft 1 can be turned by the knob 5.

After this engagement the lock tappet 3 of the lock can be turned for opening or closing the lock. It may be provided that, after a predetermined time or after the operation of the lock, a signal is generated for moving the eccentric 13 and the rod 14 to its recessed or radially withdrawn position.

1. Electromechanical lock cylinder comprising:
a housing in which a rotatable shaft is mounted that is connected to a lock tappet to operate a locking mechanism; and
at least one knob for turning said shaft, wherein, in a rest position, the knob is freely turnably arranged on said shaft and that electromechanically driven locking means are provided in said shaft or in said knob for, in an operating position, coupling the shaft with the knob, and wherein the locking means are moveable in a radial direction relative to the shaft axis to couple the shaft with the knob.

2. Electromechanical lock cylinder according to claim 1, wherein the locking means comprise at least one locking pin which is movable between a rest position in which it is not engaged with said knob or shaft and an operating position in which it is radially outwardly extended from the rest position and engaged with said knob or shaft.

3. Electromechanical lock cylinder according to claim 2, wherein the locking pin is moved by an eccentric which is driven by an electric motor drive.

4. Electromechanical lock cylinder according to claim 2, wherein the locking pin is moved by an electromechanical drive.

5. Electromechanical lock cylinder according to claim 2, wherein the locking pin is engageable with said shaft or knob in more than one position of the knob relative to the shaft.

6. Electromechanical lock cylinder according to claim 1, wherein the knob is fixed on said shaft in an axial direction of the shaft.

7. Electromechanical lock cylinder comprising:
a housing in which a rotatable shaft is mounted that is connected to a lock tappet to operate a locking mechanism; and
at least one knob for turning said shaft, wherein, in a rest position, the knob is freely turnably arranged on said shaft and that electromechanically driven locking means are provided in said shaft or in said knob for, in an operating position, coupling the shaft with the knob, and wherein said lock cylinder includes a half-cylinder comprising one knob on one end and the lock tappet on an opposite end of the housing.

8. Electromechanical lock cylinder according to claim 1, wherein said lock cylinder includes a double-sided cylinder comprising a knob on both sides.

9. Electromechanical lock cylinder according to claim 1, wherein a driving means and the locking means are arranged in said shaft and an access control unit for generating an access signal upon which the driving means will couple the knob with the shaft is arranged in said knob.

10. Electromechanical lock cylinder according to claim 1, wherein a driving means and the locking means are arranged in said knob and an access control unit for generating an access signal upon which the driving means will couple the knob with the shaft is arranged in said shaft.

11. Electromechanical lock cylinder according to claim 9, further comprising a slip ring arrangement that provides electrical communication capabilities between the access control unit and the driving means.

12. Electromechanical lock cylinder according to claim 10, further comprising a slip ring arrangement that provides electrical communication capabilities between the access control unit and the driving means.

13. Electromechanical lock cylinder comprising:
a housing in which a rotatable single piece cylindrical shaft is mounted that is connected to a lock tappet to operate a locking mechanism; and
at least one knob for turning said shaft, wherein, in a rest position, the knob is freely turnably arranged on said shaft and that electromechanically driven locking means are provided in said shaft or in said knob for, in an operating position, coupling the shaft with the knob, and wherein the locking means are moveable in a radial direction relative to the shaft axis to couple the shaft with the knob.

14. Electromechanical lock cylinder comprising:
a housing in which a rotatable shaft is mounted that is connected to a lock tappet to operate a locking mechanism; and
at least one knob for turning said shaft, wherein, in a rest position, the knob is freely turnably arranged on said shaft and that electromechanically driven locking means are provided in said shaft or in said knob for, in an operating position, coupling the shaft with the knob, and wherein the locking means are moveable in a radial direction relative to the shaft axis to engage the shaft and the knob to provide a coupling between the shaft and the knob.
